(19) United States
(12) Patent Application Publication
(10) Pub. No.: US 2008/0174529 A1
(43) Pub. Date: Jul. 24, 2008

(54) DRIVING APPARATUS AND RELATED DRIVING METHOD FOR LIGHT-EMITTING MODULES

(76) Inventors: Chi-Hsiu Lin, Yun-Lin Hsien (TW); Po-Kun Hsieh, Tao-Yuan City (TW); Shu-Wen Chang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/851,371

(22) Filed: Sep. 6, 2007

(30) Foreign Application Priority Data
Jan. 22, 2007 (TW) 096102313

(51) Int. Cl. G09G 3/32

(52) U.S. Cl. 345/82

(57) ABSTRACT

A driving apparatus for a light-emitting module is disclosed for generating a driving current to the light-emitting module according to a first input voltage and a second input voltage. The driving apparatus includes an amplifier, a first feedback circuit, and a second feedback circuit. The amplifier includes a first input node, a second input node and an output node. The first feedback circuit is used for generating a first feedback voltage inputted to the first input node according to an output voltage generated by the amplifier and the first input voltage. The second feedback circuit is used for generating a second feedback voltage inputted to the second input node according to the output voltage generated by the amplifier and the second input voltage.

### BACKGROUND OF THE INVENTION

1. Field of the Invention

The present invention relates to a technology for driving a light-emitting module, in particularly, to a driving apparatus and related driving method for providing a constant current to drive the light-emitting module.

2. Description of the Prior Art

Recently, light sources employed in light-emitting diodes (LED) have become more popular. For example, light sources in a backlight module are usually implemented with cold cathode fluorescent lamps (CCFL) in a conventional liquid crystal display (LCD) panel. However, as the optical efficiency of an LED increases repeatedly, and cost of LEDs decrease continuously, the cold cathode fluorescent lamps are replaced by light-emitting diodes gradually as light sources in a backlight module due to their being more economical.

In the prior art schemes, multiple light-emitting diodes are in series connection for reducing the number of required driving circuits, and for decreasing a total driving current utilized for driving the light-emitting diodes. However, because of process variations on light-emitting diodes during manufacturing, it is hard to ensure that parameters of the light-emitting diodes in different LED strings are identical. Additionally, the parameters of the light-emitting diodes may be usually affected by environmental factors, such as temperature, etc. For instance, the forward voltages (VF) between each light-emitting diode are usually varied by the above-mentioned characteristic. Therefore, the scheme utilizing multiple light-emitting diodes in series connection to be an LED string will accumulate differences on forward voltage caused by abovementioned characteristic. Entirely, each LED string varies on forward voltage.

In this situation, even though an identical operating voltage is applied for driving all LED strings, each LED string has its precise current passing through due to variations on forward voltage. As a result, each LED string has varied brightness because current passing through each LED string is not identical. If the foregoing LED strings are employed as light sources in a backlight module for the LCD panel, mura defects will be introduced on the display of the LCD panel. And the brightness of the lighting source in the backlight module is not uniform.

### SUMMARY OF THE INVENTION

It is an objective of the present invention to provide a driving apparatus and related driving method for providing a constant current to drive a light-emitting module to avoid foregoing issue.

Regarding to the present invention, a driving apparatus for a light-emitting module employed in generating a driving current to the light-emitting module according to a first input voltage and a second input voltage is disclosed. The driving apparatus includes an amplifier, a first feedback circuit, and a second feedback circuit. The amplifier includes a first input node, a second input node, and an output node. The first feedback circuit is used for generating a first feedback voltage inputted to the first input node of the amplifier according to an output voltage generated by the amplifier and the first input voltage. The second feedback circuit is employed in generating a second feedback voltage inputted to the second input node of the amplifier according to the output voltage generated by the amplifier and the second input voltage.

Regarding to the present invention, a driving method for driving a light-emitting module used for generating a driving current to the light-emitting module according to a first input voltage and a second input voltage is disclosed. The driving method includes to provide an amplifier having a first input node, a second input node, and an output node. The second input node of the amplifier is electrically coupled to the light-emitting module. A first feedback voltage is generated and inputted to the first input node of the amplifier according to an output voltage generated by the amplifier and the first input voltage. A second feedback voltage is generated and inputted to the second input node of the amplifier according to the output voltage generated by the amplifier and the second input voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a driving apparatus for driving a light-emitting module according to a first embodiment of the present invention.

FIG. 2 is a diagram of a driving apparatus for driving a light-emitting module according to a second embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

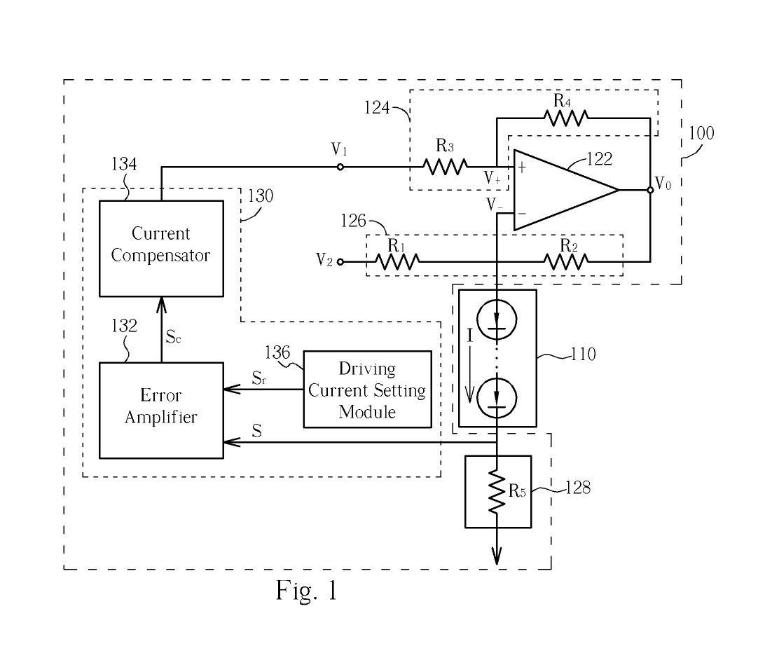

Referring to FIG. 1, which is a diagram of a driving apparatus 100 for driving a light-emitting module 110 according to a first embodiment of the present invention. As shown in FIG. 1, the driving apparatus 100 is used for driving the light-emitting module 110. The driving apparatus 100 can be applied to backlight modules of liquid crystal displays (LCD) and the light-emitting module 110 including at least one light-emitting diode for providing a light source for LCD panels. Please note that the present invention utilizes a light-emitting diode as embodiments for illustration, but is not limited to the embodiments of the present invention only. That is, the driving apparatus 100 can also be applied to drive a light-emitting module composed of other light emitting components through providing a constant current. Furthermore, the number of the light-emitting diodes shown in FIG. 1 is just for example, and should not be limitation of the present invention. The driving apparatus 100 is coupled to the light-emitting module 110 for generating a driving current I to the light-emitting module 110 according to a first input voltage V₁ and a second input voltage V₂.

In this embodiment, the driving apparatus 100 includes an amplifier 122, a first feedback circuit 124, a second feedback circuit 126, a third feedback circuit 128, and a feedback control circuit 130. The amplifier 122 includes a first input node (+), a second input node (−), and an output node, wherein the second input node (−) is coupled to the light-emitting module 110. The first feedback circuit 124 is coupled to the first input voltage V₁ and to the first input node (+), and the output node of the amplifier 122 is used for generating a first feedback voltage V₊ inputted to the first input node (+) according to an output voltage Vₒ generated by the amplifier 122 and the first input voltage V₁. The second feedback circuit 126 is coupled to the second input voltage V₂ and to the second input node (−), and the output node of the amplifier 122 is used for generating a second feedback voltage V₋ inputted to the second input node (−) according to the output voltage Vₒ generated by the amplifier 122 and the second input voltage V₂. As shown in FIG. 1, the second feedback circuit 126 includes a first impedance R₁ having one node coupled to the second input node (−) of the amplifier 122 and another node for receiving the first input voltage V₁ and second impedance R₂ coupled to the second input node (−) and the output node of the amplifier 122. Moreover, the first feedback circuit 124 includes a third impedance R₃ having one node coupled to the first input node (+) of the amplifier 122 and another node for receiving a second input voltage V₂ and a fourth impedance R₄ coupled to the first input node (+) and the output node of the amplifier 122.

As shown in FIG. 1, the third feedback circuit 128 is coupled to the light-emitting module 110 for generating a third feedback signal S according to the driving current I. Moreover, the feedback control circuit 130 is coupled to the third feedback circuit 128 and to the second feedback circuit 126 for adjusting the first input voltage V₁ to adjust the driving current I according to the third feedback signal S. In this embodiment, the feedback control signal 130 includes an error amplifier 132, a current compensator 134, and a driving current setting module 136, wherein the error amplifier 132 is used for comparing the third feedback signal S with a reference signal Sᵣ to generate a comparison signal S_{c}. The current compensator 134 is coupled to the error amplifier 132 for receiving the comparison signal S_{c} to generate the first input voltage V₁. The driving current setting module 136 is coupled to the error amplifier 132 for adjusting the reference signal Sᵣ to generate the driving current I.

Referring to FIG. 1 again, as the driving apparatus 100, when the amplifier 122 operates under negative feedback amplifier states, it can be known that:

V₊=V₋ (1)

From a viewpoint of the second feedback circuit 126, the driving current I has the equation as shown in following:

$$I = \frac{{V}_{2} - {V}_{-}}{{R}_{1}} + \frac{{V}_{o} - {V}_{-}}{{R}_{2}} \qquad ( 2 )$$

From a viewpoint of the first feedback circuit 124, the output voltage Vₒ has the equation as shown in following:

$${V}_{o} = \frac{{V}_{+} - {V}_{1}}{{R}_{3}} \cdot {R}_{4} + {V}_{+} \qquad ( 3 )$$

Therefore, the driving current I can be obtained from the equations (1), (2), and (3) as shown in following:

$$I = \frac{{V}_{2} - {V}_{-}}{{R}_{1}} + \frac{{V}_{-} - {V}_{1}}{{R}_{3} \cdot {R}_{2}} \cdot {R}_{4} \qquad ( 4 )$$

In the present invention, an impedance value of the first impedance R₁ equaling an impedance value of the second impedance R₂ (R₁=R₂) is selected, and an impedance value of the third impedance R₃ equaling an impedance value of the fourth impedance R₄ (R₃=R₄) is selected. However, this is only a preferred embodiment, which is not a limitation to the present invention. Placing R₁=R₂ and R₃=R₄ into the equation (4), then the driving current I can be obtained:

$$I = \frac{{V}_{2} - {V}_{1}}{{R}_{1}} \qquad ( 5 )$$

Thus it can be seen, the driving current I is only relative to the first input voltage V₁, the second voltage V₂, and the impedance value of the first impedance R₁. However, it is not relative to the self impedance value of the light-emitting module 110.

Referring to FIG. 1. In this embodiment, the driving apparatus 100 that outputs the driving current I to drive the light-emitting module 110 and the third feedback circuit 128 includes a fifth impedance R₅. Therefore, the third feedback signal S is generated when the driving current I flows through the fifth impedance R₅. At this time, the error amplifier 132 compares the third feedback signal S with the reference signal Sᵣ setting by the driving current setting module 136 to generate the comparison signal S_{c}. Finally, the current compensator 134 will receive the comparison signal S_{c} to generate the first input voltage V₁ to adjust the driving current I. The third feedback signal S is too large when the driving current I is too large, and then the error amplifier 132 judges that the third feedback signal S is greater than the reference signal Sᵣ. The comparison signal S_{c} is positive, thus the current compensator 134 will increase the second input voltage V₂. Thus it can be seen from the equation (5), the driving current I will decrease. Oppositely, the third feedback signal S is too small when the driving current I is too smaller, and then the error amplifier 132 judges that the third feedback signal S is smaller than the reference signal Sᵣ. The comparison signal S_{c} is negative, thus the current compensator 134 will decrease the second input voltage V₂. Thus it can be seen from the equation (5), the driving current I will increase.

Please note that, if the luminance of the light-emitting module 110 needs to be adjusted dynamically (that is adjusting the driving current I), the driving current setting module 136 can be utilized for setting different reference signals Sᵣ dynamically to control the first input voltage V₁ to fix at a needed voltage level to reach the goal of setting the driving current I. For example, when the reference signal Sᵣ increases, the first input voltage V₁ can be lowered by the current compensator 134 to increase the driving current I through the feedback mechanism. According to the equation (5), one skilled in the art will appreciate that the luminance of the light-emitting module 110 can be lowered through lowering the reference signal Sᵣ in this continuous mode. On the other hand, the luminance of the light-emitting module 110 can be increased (that is enlarging the driving current I) through lowering the reference signal Sᵣ.

Please note that the first input node (+) can be coupled to ground, and the second input node (−) equals the ground voltage in the present invention. Therefore, the driving current I has the equation as shown in following:

$$I = \frac{{V}_{2}}{{R}_{1}} .$$

That is to say, the driving current I can be obtained by controlling the second input voltage V₂ and the impedance value of the first impedance R₁. Although this kind of state can not utilize the feedback mechanism to adjust the driving current I dynamically, it can reach the goal of driving the light-emitting module 110, which belongs to the scope of the present invention.

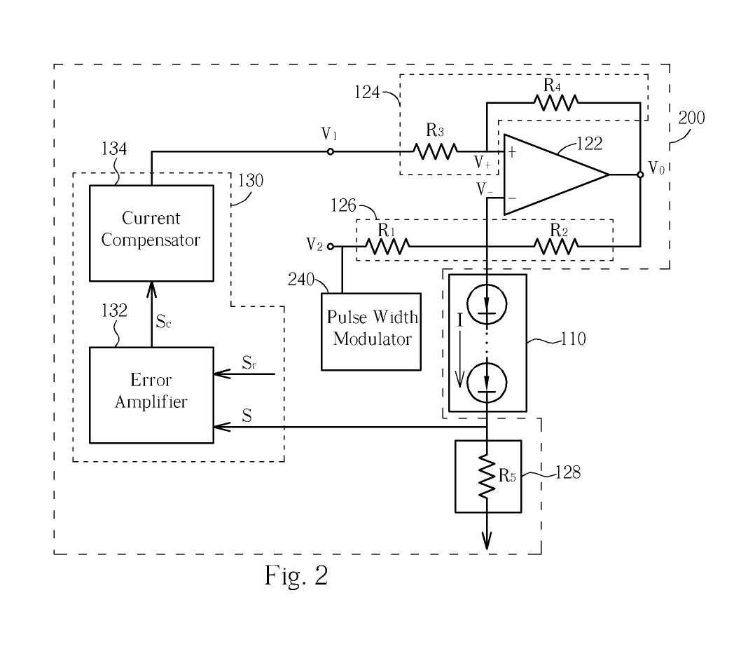

Referring to FIG. 2, which is a diagram of a driving apparatus 200 for driving the light-emitting module 110 according to a second embodiment of the present invention. Please note that the components in FIG. 2 are mostly the same as the components in FIG. 1, and their driving methods for driving the light-emitting module 110 are the same. The difference between them is that a pulse width modulator 240 is added to replace the driving current setting module 136, and the luminance of the light-emitting module 110 is controlled by the pulse width modulation mechanism. As shown in FIG. 2, the pulse width modulator 240 is coupled to the second feedback circuit 126 for providing a pulse width modulation signal to adjust the second input voltage V₂ to further adjust a frequency of the driving current I (as shown in the equation (5):

$$I = \frac{{V}_{2} - {V}_{1}}{{R}_{1}} )$$

and to adjust the luminance of the light-emitting module 110.

For example, the driving apparatus 200 drives the light-emitting module 110 by the driving current I, thus the driving current I defines the luminance of the light-emitting module 110 (such as a gray value of 255). In order to keep the luminance of the light-emitting module 110 corresponding to the gray value of 255, the driving apparatus 200 will drive the light-emitting module 110 by utilizing the driving current I as a basis continuously. If one user desires to adjust the luminance of the light-emitting module 110, such as lowering the original luminance to one half, the driving apparatus 200 will still drive the light-emitting module 110 according to the driving current I (that is keep the second voltage V₂ the same), but change the driving time for a pulse width bust mode. For example, the driving apparatus 200 utilizes only 1/400 second to drive the light-emitting module 110 during each 1/200 second. That is, the frequency can be seen as 200 Hz, and its duty cycle is 50% for the driving current I. In other words, it equivalently utilizes a current value of 0.5×I to define the luminance of the light-emitting module 110, which can lower the luminance of the light-emitting module 110. Hence, the pulse width mode can adjust the duty cycle of the driving current I under a predetermined frequency (such as 200 Hz) to equivalently change the current value and further to change the corresponding luminance.

In comparison with the prior art, the present invention not only can be used as block control but also can simplify circuits to lower the cost. Moreover, the driving current becomes more stable, and will not change as loading changes. Therefore, the luminance of backlight source tends to be identical.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving apparatus of a light-emitting module used for generating a driving current to the light-emitting module according to a first input voltage and a second input voltage, the driving apparatus comprising:
an amplifier comprising a first input node, a second input node, and an output node, wherein the second input node is coupled to the light-emitting module;
a first feedback circuit coupled to the first input voltage, to the first input node, and to the output node for generating a first feedback voltage inputted to the first input node according to an output voltage generated by the amplifier and the first input voltage; and
a second feedback circuit coupled to the second input voltage, to the second input node, and to the output node for generating a second feedback voltage inputted to the second input node according to the output voltage generated by the amplifier and the second input voltage.

2. The driving apparatus of claim 1, wherein the second feedback circuit comprises:
a first impedance having one node coupled to the second input node and another node used for receiving the first input voltage; and
a second impedance coupled between the second input node and the output node; and
the first feedback circuit comprises:
a third impedance having one node coupled to the first input node and another node used for receiving the second input voltage; and
a fourth impedance coupled between the first input node and the output node.

3. The driving apparatus of claim 2, wherein an impedance value of the first impedance equals an impedance value of the second impedance, and an impedance value of the third impedance equals an impedance value of the fourth impedance.

4. The driving apparatus of claim 1 further comprising:
a third feedback circuit coupled to the light-emitting module for generating a third feedback signal according to the driving current; and
a feedback control circuit coupled to the third feedback circuit and to the second feedback circuit for adjusting the first input voltage to adjust the driving current according to the third feedback signal.

5. The driving apparatus of claim 4, wherein the feedback control circuit comprises:
an error amplifier used for comparing the third feedback signal with a reference signal to generate a comparison signal; and
a current compensator coupled to the error amplifier for receiving the comparison signal to generate the first input voltage.

6. The driving apparatus of claim 5 further comprising:
a driving current setting module coupled to the error amplifier for adjusting the reference signal to control the driving current.

7. The driving apparatus of claim 1 further comprising:
a pulse width modulator coupled to the second feedback circuit for providing a pulse width modulation signal to adjust the second input voltage.

8. The driving apparatus of claim 1, wherein the driving apparatus is installed in a backlight module of a liquid crystal display.

9. The driving apparatus of claim 1, wherein the light-emitting module is a light diode module having at least one light diode.

10. A driving method for driving a light-emitting module used for generating a driving current to the light-emitting module according to a first input voltage and a second input voltage, the driving method comprising:
providing an amplifier having a first input node, a second input node and an output node, and electrically coupling the second input node to the light-emitting module;
generating a first feedback voltage inputted to the first input node according to an output voltage generated by the amplifier and the first input voltage; and
generating a second feedback voltage inputted to the second input node according to the output voltage generated by the amplifier and the second input voltage.

11. The driving method of claim 10 further comprising:
generating a third feedback signal according to the driving current; and
adjusting the first input voltage to adjust the driving current according to the third feedback signal.

12. The driving method of claim 11, wherein the step of adjusting the first input voltage according to the third feedback signal further comprises:
comparing the third feedback signal with a reference signal to generate a comparison signal; and
generating the first input voltage according to the comparison signal.

13. The driving method of claim 12 further comprising:
adjusting the reference signal to control the driving current.

14. The driving method of claim 10 further comprising:
providing a pulse width modulation signal to adjust the second input voltage.

15. The driving method of claim 10, wherein the light-emitting module is a light diode module having at least one light diode.
